(19) United States
(12) Patent Application Publication
(10) Pub. No.: US 2017/0014653 A1
(43) Pub. Date: Jan. 19, 2017

(54) Filtering Face-Piece Respirator With Increased Friction Perimeter

(71) Applicant: 3M INNOVATIVE PROPERTIES COMPANY, St. Paul, MN (US)

(72) Inventor: Dean R. Duffy, Woodbury, MN (US)

(21) Appl. No.: 15/279,521

(22) Filed: Sep. 29, 2016

Related U.S. Application Data
(62) Division of application No. 14/052,979, filed on Oct. 14, 2013.

(51) Int. Cl. A62B 18/08; A62B 18/10; A41D 13/11; A62B 18/02; A62B 23/02

(52) U.S. Cl. CPC A62B 18/084; A62B 18/02; A62B 23/025; A41D 13/1161; A41D 13/1115; A62B 18/10

(57) ABSTRACT

A filtering face-piece respirator 10 that includes a harness 14 and a mask body 12 that has a multi-layer filtering structure 16. Present at the perimeter 24 on the interior surface of the mask body 12 is a region having an increased coefficient of friction 44, in relation to the filtering structure 16. This region 44 can be formed by a discontinuous coating of a polymeric material. The region 44 improves the fit of the respirator 10 on the wearer's face, providing a non-slip seal, yet allows moisture laden air to exit from the interior gas space of the mask body 12.

The present invention pertains to a filtering face-piece respirator that includes a perimeter having an increased coefficient of friction.

### BACKGROUND

Respirators are commonly worn over a person's breathing passages for at least one of two common purposes: (1) to prevent impurities or contaminants from entering the wearer's respiratory system; and (2) to protect other persons or things from being exposed to pathogens and other contaminants exhaled by the wearer. In the first situation, the respirator is worn in an environment where the air contains particles that are harmful to the wearer, for example, in an auto body shop. In the second situation, the respirator is worn in an environment where there is risk of contamination to other persons or things, for example, in an operating room or clean room.

A variety of respirators have been designed to meet either (or both) of these purposes. Some respirators have been categorized as being “filtering face-pieces” because the mask body itself functions as the filtering mechanism. Unlike respirators that use rubber or elastomeric mask bodies in conjunction with attachable filter cartridges (see, e.g., U.S. Pat. RE39,493 to Yuschak et al.) or insert-molded filter elements (see, e.g., U.S. Pat. No. 4,790,306 to Braun), filtering face-piece respirators are designed to have the filter media cover much of the whole mask body so that there is no need for installing or replacing a filter cartridge. These filtering face-piece respirators commonly come in one of two configurations: molded respirators and flat-fold respirators.

Molded filtering face piece respirators have regularly comprised non-woven webs of thermally-bonding fibers or open-work plastic meshes to furnish the mask body with its cup-shaped configuration. Molded respirators tend to maintain the same shape during both use and storage. These respirators therefore cannot be folded flat for storage and shipping. Examples of patents that disclose molded, filtering face-piece respirators include U.S. Pat. No. 7,131,442 to Kronzer et al, U.S. Pat. Nos. 6,923,182, 6,041,782 to Angadjivand et al., U.S. Pat. No. 4,807,619 to Dyrud et al., and U.S. Pat. No. 4,536,440 to Berg.

Flat-fold respirators—as their name implies—can be folded flat for shipping and storage. They also can be opened into a cup-shaped configuration for use. Examples of flat-fold respirators are shown in U.S. Pat. Nos. 6,568,392 and 6,484,722 to Bostock et al., and U.S. Pat. No. 6,394,090 to Chen. Some flat-fold respirators have been designed with weld lines, seams, and folds, to help maintain their cup-shaped configuration during use. Stiffening members also have been incorporated into panels of the mask body (see U.S. Patent Application Publications 2001/0067700 to Duffy et al., 2010/0154805 to Duffy et al., and U.S. Design Pat. 659,821 to Spoo et al.).

Some respirators have been designed with a fluid barrier between the periphery of the mask and the wearer's face. See, for example, U.S. Pat. Nos. 5,724,964 and 6,055,982 to Brunson et al. and U.S. Pat. No. 6,173,712 to Brunson. These Brunson patents utilize a gasket-type sealing material such as a plastic film or a hydrogel to form the fluid barrier.

The present invention, as described below, provides an improved fitting and improved sealing, comfortable flat-fold respirator having a periphery member.

### SUMMARY OF THE INVENTION

The present invention provides a filtering face-piece respirator that comprises a mask body having a perimeter that includes a region having an increased coefficient of friction, as compared to the mask body. The region of increased coefficient of friction, in some embodiments, is formed by applying a fluid permeable, slip resistant non-adhesive friction member onto the interior surface of the mask perimeter. In some embodiments, the entire mask perimeter includes the friction member. In some embodiments, the friction member wraps from the interior surface of the mask to the exterior surface.

The increased coefficient of friction surface improves the sealing of the mask body to the wearer's face without creating a vapor barrier that could result in moisture build-up between the mask body and the wearer's face.

### GLOSSARY

The terms set forth below will have the meanings as defined:

“comprises” or “comprising” means its definition as is standard in patent terminology, being an open-ended term that is generally synonymous with “includes”, “having”, or “containing”. Although “comprises”, “includes”, “having”, and “containing” and variations thereof are commonly-used, open-ended terms, this invention also may be suitably described using narrower terms such as “consists essentially of”, which is semi open-ended term in that it excludes only those things or elements that would have a deleterious effect on the performance of the inventive respirator in serving its intended function;

“clean air” means a volume of atmospheric ambient air that has been filtered to remove contaminants;

“coefficient of friction” means the measure of the amount of resistance that a surface exerts on or substances moving over it, or, the ratio between the maximal frictional force that the surface exerts and the force pushing the object toward the surface; a “static coefficient of friction” is the coefficient of friction that applies to objects that are motionless, whereas a “dynamic coefficient of friction” is the coefficient of friction that applies to objects that are in motion; the coefficient of friction is measured in accordance with ASTM D1894-11e1;

“contaminants” means particles (including dusts, mists, and fumes) and/or other substances that generally may not be considered to be particles (e.g., organic vapors, etc.) but which may be suspended in air;

“crosswise dimension” is the dimension that extends laterally across the respirator, from side-to-side when the respirator is viewed from the front;

“cup-shaped configuration”, and variations thereof, means any vessel-type shape that is capable of adequately covering the nose and mouth of a person;

“exterior gas space” means the ambient atmospheric gas space into which exhaled gas enters after passing through and beyond the mask body and/or exhalation valve;

“exterior surface” means the surface of the mask body exposed to ambient atmospheric gas space when the mask body is positioned on the person's face;

“filtering face-piece” means that the mask body itself is designed to filter air that passes through it; there are no separately identifiable filter cartridges or insert-molded filter elements attached to or molded into the mask body to achieve this purpose;

“filter” or “filtration layer” means one or more layers of air-permeable material, which layer(s) is adapted for the primary purpose of removing contaminants (such as particles) from an air stream that passes through it;

“filter media” means an air-permeable structure that is designed to remove contaminants from air that passes through it;

“filtering structure” means a generally air-permeable construction that filters air;

“folded inwardly” means being bent back towards the part from which extends;

“harness” means a structure or combination of parts that assists in supporting the mask body on a wearer's face;

“interior gas space” means the space between a mask body and a person's face;

“interior perimeter” means the outer edge of the mask body, on the interior surface of the mask body, which would be disposed generally in contact with a wearer's face when the respirator is positioned on the wearer's face;

“interior surface” means the surface of the mask body closest to a person's face when the mask body is positioned on the person's face;

“line of demarcation” means a fold, seam, weld line, bond line, stitch line, hinge line, and/or any combination thereof;

“mask body” means an air-permeable structure that is designed to fit over the nose and mouth of a person and that helps define an interior gas space separated from an exterior gas space (including the seams and bonds that join layers and parts thereof together);

“nose clip” means a mechanical device (other than a nose foam), which device is adapted for use on a mask body to improve the seal at least around a wearer's nose;

“perimeter” means the outer edge of the mask body, which outer edge would be disposed generally proximate to a wearer's face when the respirator is being donned by a person; a “perimeter segment” is a portion of the perimeter;

“permeable” and “permeability” mean the ability to pass air through a material, and is measured by a Frazier Air Permeability Machine and in accordance with ASTM D461-67;

“pleat” means a portion that is designed to be or is folded back upon itself;

“polymeric” and “plastic” each mean a material that mainly includes one or more polymers and that may contain other ingredients as well;

“respirator” means an air filtration device that is worn by a person to provide the wearer with clean air to breathe; and

“transversely extending” means extending generally in the crosswise dimension.

### BRIEF DESCRIPTION OF THE DRAWINGS

FIG. 1 is a front perspective view of a flat-fold filtering face-piece respirator 10 being worn on a person's face, the respirator 10 having a mask body 12;

FIG. 2 is a side view of the respirator 10 of FIG. 1;

FIG. 3 is a front view of a mask body 12 of respirator 10 of FIG. 1;

FIG. 4a is a bottom view of the mask body 12 in a flat configuration with the flanges 30a, 30b in an unfolded position;

FIG. 4b is a bottom view of the mask body 12 in a pre-opened configuration with the flanges 30a, 30b folded against the filtering structure 16;

FIG. 5 is a cross-sectional view of a filtering structure 16 suitable for use in the mask body 12 of FIG. 1;

FIG. 6 is a back view of the mask body 12 of FIG. 3 showing a region of increased coefficient of friction 44;

FIG. 6A is a cross-sectional view of an embodiment of a portion of the region of increased coefficient of friction 44 taken along lines 6-6 of FIG. 6;

FIG. 6B is a cross-sectional view of another embodiment of a portion of the region of increased coefficient of friction 44 taken along lines 6-6 of FIG. 6;

FIG. 7 is a top view of a friction member 46 suitable for use in the region of increased coefficient of friction 44 of mask body 12 of FIG. 6;

FIG. 8 is a top view of another embodiment of a friction member 46 suitable for use in the region of increased coefficient of friction 44 of mask body 12 of FIG. 6;

FIG. 9 is a top view of another embodiment of a friction member 46 suitable for use in the region of increased coefficient of friction 44 of mask body 12 of FIG. 6; and

FIG. 10 schematically shows a process for forming a flat-fold filtering face-piece respirator having the mask body 12 and the region of increased coefficient of friction 44 formed from a friction member 46.

### DETAILED DESCRIPTION OF PREFERRED EMBODIMENTS

In practicing the present invention, a filtering face-piece respirator is provided that has an increased coefficient of friction, as compared to the coefficient of friction of the filtering structure of the respirator, at the perimeter of the interior surface of the mask body. The frictional member enhances the fit and sealing of the respirator to the face of the wearer while allowing fluid (e.g., moisture laden air) to permeate from the interior gas space to the exterior gas space.

In the following description, reference is made to the accompanying drawings that form a part hereof and in which are shown by way of illustration various specific embodiments. The various elements and reference numerals of one embodiment described herein are consistent with and the same as the similar elements and reference numerals of another embodiment described herein, unless indicated otherwise. It is to be understood that other embodiments are contemplated and may be made without departing from the scope or spirit of the present invention. The following description, therefore, is not to be taken in a limiting sense. While the present invention is not so limited, an appreciation of various aspects of the invention will be gained through a discussion of the examples provided below.

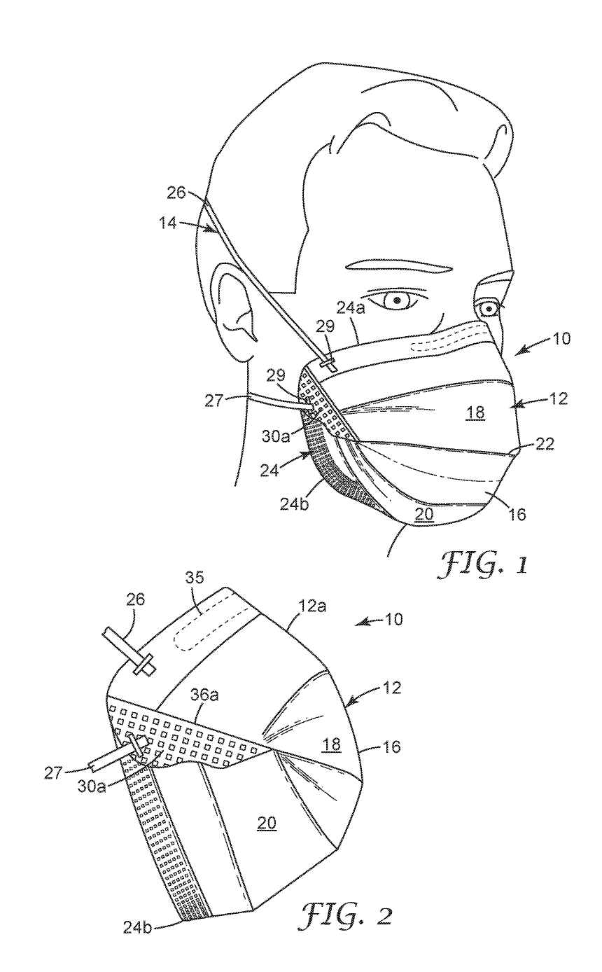

Turning to the figures, FIGS. 1 and 2 show an example of a filtering face-piece respirator 10 that may be used in connection with the present invention to provide clean air for the wearer to breathe. The filtering face-piece respirator 10 includes a mask body 12 and a harness 14. The mask body 12 has a filtering structure 16 through which inhaled air must pass before entering the wearer's respiratory system. The filtering structure 16 removes contaminants from the ambient environment so that the wearer breathes clean air. The filtering structure 16 may take on a variety of different shapes and configurations and typically is adapted so that it properly fits against the wearer's face or within a support structure. Generally the shape and configuration of the filtering structure 16 corresponds to the general shape of the mask body 12.

The mask body 12 includes a top portion 18 and a bottom portion 20 separated by a line of demarcation 22. In this particular embodiment, the line of demarcation 22 is a fold or pleat that extends transversely across the central portion of the mask body from side-to-side. The mask body 12 also includes a perimeter 24 that includes an upper segment 24a at top portion 18 and a lower segment 24b at bottom portion 20.

The harness 14 (FIG. 1) has a first, upper strap 26 that is secured to the top portion 18 of mask body 12 and a second, lower strap 27. The straps 26, 27 are secured to mask body 12 by staples 29. The straps 26, 27 may be made from a variety of materials, such as thermoset rubbers, thermoplastic elastomers, braided or knitted yarn and/or rubber combinations, inelastic braided components, and the like. The straps 26, 27 preferably can be expanded to greater than twice their total length and be returned to their relaxed state. The straps 26, 27 also could possibly be increased to three or four times their relaxed state length and can be returned to their original condition without any damage thereto when the tensile forces are removed. The straps 26, 27 may be continuous straps or may have a plurality of parts, which can be joined together by further fasteners or buckles. Alternatively, the straps may form a loop that is placed around the wearer's ears.

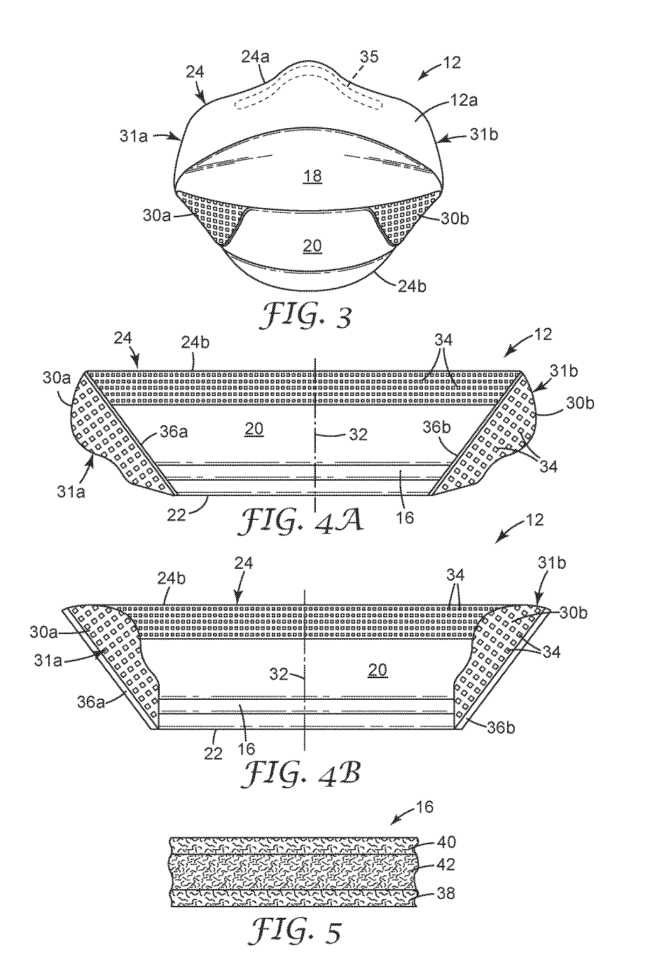

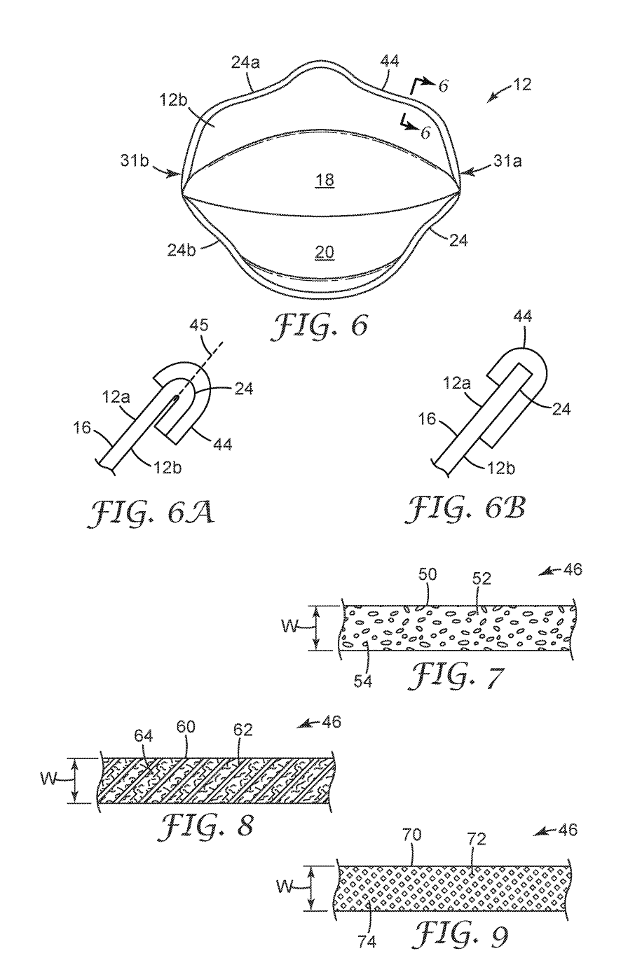

FIGS. 3 and 6 show the mask body 12 of the respirator 10 without the harness 14, FIGS. 4a and 4b show the mask body 12 in a folded or collapsed configuration; this configuration may also be referred to as a pre-opened configuration. Additional features and details of respirator 10 and mask body 12 can be seen in these configurations.

The mask body 12 with first and second flanges 30a and 30b located on opposing sides 31a, 31b of the mask body 12. Straps 26, 27 (FIGS. 1, 2) are attached to the mask body 12 and extend from side 31a to side 31b. As indicated above, the first, upper strap 26 is secured to the top portion 18 of mask body 12 adjacent to the perimeter upper segment 24a, whereas the second, lower strap 27 is stapled to flanges 30a, 30b (see FIG. 2).

A nose clip 35 can be disposed on the top portion 18 of the mask body 12 adjacent to the upper perimeter segment 24a, centrally positioned between the mask body side edges, to assist in achieving an appropriate fit on and around the nose and upper cheek bones. The nose clip 35 may be made from a pliable metal or plastic that is capable of being manually adapted by the wearer to fit the contour of the wearer's nose. The nose clip 35 may comprise, for example, a malleable or pliable soft band of metal such as aluminum, which can be shaped to hold the mask in a desired fitting relationship over the nose of the wearer and where the nose meets the cheek.

Turning to FIGS. 4a and 4b, a plane 32 bisects the mask body 12 to define the first and second sides 31a, 31b. The first and second flanges 30a and 30b located on opposing sides 31a and 31b, respectively, of the mask body 12 can be readily seen, particularly in FIG. 4a. The flanges 30a, 30b typically extend away from the mask body 12 and may be integrally or non-integrally connected to the major portion of the mask body 12 at first and second lines of demarcation 36a, 36b. The flanges 30a, 30b may be an extension of the filtering structure 16, or they may be made from a separate material such as a rigid or semi-rigid plastic. Although the flanges 30a, 30b may comprise one or more or all of the various layers that comprise the mask body filtering structure 16, the flanges 30a, 30b are not part of the primary filtering area of the mask body 12. Unlike the filtering structure 16, the layers that comprise the flanges 30a, 30b may be compressed, rendering them nearly fluid impermeable. The flanges 30a, 30b can have welds or bonds 34 thereon to increase flange stiffness, and the mask body perimeter lower segment 24b also may have a series of bonds or welds 34 to join the various layers of the mask body 12 together. The flanges 30a, 30b may be rotated or folded about an axis or fold line generally parallel, close to parallel, or at an angle of no more than about 30 degrees to these demarcation lines 36a, 36b to form the configuration of FIG. 4b. Additional details regarding flanges 30a and 30b and other features of respirator 10 and mask body 12 can be found in U.S. patent application Ser. No. 13/727,923 filed Dec. 27, 2012, titled “Filtering Face-Piece Respirator Having Folded Flange,” the entire disclosure of which is incorporated herein by reference.

Perimeter segment 24a also may have a series of bonds or welds to join the various layers together and also to maintain the position of a nose clip 35. The remainder of the filtering structure 16—inwardly from the perimeter—may be fully fluid permeable over much of its extended surface, with the possible exception of areas where there are bonds, welds, or fold lines. The bottom portion 20 may include one or more pleat lines that extend from the first line of demarcation 36a to the second line of demarcation 36b transversely.

The filtering structure 16 that is used in the mask body 12 can be of a particle capture or gas and vapor type filter. The filtering structure 16 also may be a barrier layer that prevents the transfer of liquid from one side of the filter layer to another to prevent, for instance, liquid aerosols or liquid splashes (e.g., blood) from penetrating the filter layer. Multiple layers of similar or dissimilar filter media may be used to construct the filtering structure 16 as the application requires. Filtration layers that may be beneficially employed in a layered mask body are generally low in pressure drop (for example, less than about 195 to 295 Pascals at a face velocity of 13.8 centimeters per second) to minimize the breathing work of the mask wearer. Filtration layers additionally may be flexible and may have sufficient shear strength so that they generally retain their structure under the expected use conditions.

FIG. 5 shows an exemplary filtering structure 16 having multiple layers such as an inner cover web 38, an outer cover web 40, and a filtration layer 42. The filtering structure 16 also may have a structural netting or mesh juxtaposed against at least one or more of the layers 38, 40, or 42, typically against the outer surface of the outer cover web 40, that assist in providing a cup-shaped configuration. The filtering structure 16 also could have one or more horizontal and/or vertical lines of demarcation (e.g., pleat, fold, or rib) that contribute to its structural integrity.

An inner cover web 38, which typically defines the interior surface 12b (FIG. 6) of the mask body 12, can be used to provide a smooth surface for contacting the wearer's face, and an outer cover web 40, which typically defines the exterior surface 12a (FIGS. 2 and 3) of the mask body 12, can be used to entrap loose fibers in the mask body or for aesthetic reasons. Both cover webs 38, 40 protect the filtration layer 42. The cover webs 38, 40 typically do not provide any substantial filtering benefits to the filtering structure 16, although outer cover web 40 can act as a pre-filter to the filtration layer 42.

To obtain a suitable degree of comfort, the inner cover web 38 preferably has a comparatively low basis weight and is formed from comparatively fine fibers, often finer than those of outer cover web 40. Either or both cover webs 38, 40 may be fashioned to have a basis weight of about 5 to about 70 g/m² (typically about 17 to 51 g/m² and in some embodiments 34 to 51 g/m²), and the fibers may be less than 3.5 denier (typically less than 2 denier, and more typically less than 1 denier) but greater than 0.1. Fibers used in the cover webs 38, 40 often have an average fiber diameter of about 5 to 24 micrometers, typically of about 7 to 18 micrometers, and more typically of about 8 to 12 micrometers. The cover web material may have a degree of elasticity (typically, but not necessarily, 100 to 200% at break) and may be plastically deformable.

Typically, the cover webs 38, 40 are made from a selection of nonwoven materials that provide a comfortable feel, particularly on the side of the filtering structure that makes contact with the wearer's face, i.e., inner cover web 38. Suitable materials for the cover web may be blown microfiber (BMF) materials, particularly polyolefin BMF materials, for example polypropylene BMF materials (including polypropylene blends and also blends of polypropylene and polyethylene). Spun-bond fibers also may be used.

A typical cover web may be made from polypropylene or a polypropylene/polyolefin blend that contains 50 weight percent or more polypropylene. Polyolefin materials that are suitable for use in a cover web may include, for example, a single polypropylene, blends of two polypropylenes, and blends of polypropylene and polyethylene, blends of polypropylene and poly(4-methyl-1-pentene), and/or blends of polypropylene and polybutylene. Cover webs 38, 40 preferably have very few fibers protruding from the web surface after processing and therefore have a smooth outer surface.

The filtration layer 42 is typically chosen to achieve a desired filtering effect. The filtration layer 42 generally will remove a high percentage of particles and/or or other contaminants from the gaseous stream that passes through it. For fibrous filter layers, the fibers selected depend upon the kind of substance to be filtered.

The filtration layer 42 may come in a variety of shapes and forms and typically has a thickness of about 0.2 millimeters (mm) to 5 mm, more typically about 0.3 mm to 3 mm (e.g., about 0.5 mm), and it could be a generally planar web or it could be corrugated to provide an expanded surface area. The filtration layer also may include multiple filtration layers joined together by an adhesive or any other means. Essentially any suitable material that is known (or later developed) for forming a filtering layer may be used as the filtering material. Webs of melt-blown fibers, especially when in a persistent electrically charged (electret) form are especially useful. Electrically charged fibrillated-film fibers also may be suitable, as well as rosin-wool fibrous webs and webs of glass fibers or solution-blown, or electrostatically sprayed fibers, especially in microfilm form. Also, additives can be included in the fibers to enhance the filtration performance of webs produced through a hydro-charging process. Fluorine atoms, in particular, can be disposed at the surface of the fibers in the filter layer to improve filtration performance in an oily mist environment.

Examples of particle capture filters include one or more webs of fine inorganic fibers (such as fiberglass) or polymeric synthetic fibers. Synthetic fiber webs may include electret-charged, polymeric microfibers that are produced from processes such as meltblowing. Polyolefin microfibers formed from polypropylene that has been electrically-charged provide particular utility for particulate capture applications. An alternate filter layer may comprise a sorbent component for removing hazardous or odorous gases from the breathing air. Sorbents may include powders or granules that are bound in a filter layer by adhesives, binders, or fibrous structures. A sorbent layer can be formed by coating a substrate, such as fibrous or reticulated foam, to form a thin coherent layer. Sorbent materials may include activated carbons that are chemically treated or not, porous alumina-silica catalyst substrates, and alumina particles.

Although the filtering structure 16 has been illustrated in FIG. 5 with one filtration layer 42 and two cover webs 38, 40, the filtering structure 16 may comprise a plurality or a combination of filtration layers 42. For example, a pre-filter may be disposed upstream to a more refined and selective downstream filtration layer. Additionally, sorptive materials such as activated carbon may be disposed between the fibers and/or various layers that comprise the filtering structure. Further, separate particulate filtration layers may be used in conjunction with sorptive layers to provide filtration for both particulates and vapors.

During respirator use, incoming air passes sequentially through layers 40, 42, and 38 before entering the mask interior. The air that is within the interior gas space of the mask body may then be inhaled by the wearer. When a wearer exhales, the air passes in the opposite direction sequentially through layers 38, 42, and 40. Alternatively, an exhalation valve (not shown) may be provided on the mask body 12 to allow exhaled air to be rapidly purged from the interior gas space to enter the exterior gas space without passing through filtering structure 16. The use of an exhalation valve may improve wearer comfort by rapidly removing the warm moist exhaled air from the mask interior. Essentially any exhalation valve that provides a suitable pressure drop and that can be properly secured to the mask body may be used in connection with the present invention to rapidly deliver exhaled air from the interior gas space to the exterior gas space.

FIGS. 3 and 6 illustrate the mask body 12 of the respirator 10 but without the harness 14. These figures show the top portion 18 and the bottom portion 20, the perimeter 24 including the upper segment 24a at the top portion 18 and the lower segment 24b at the bottom portion 20, and flanges 30a, 30b (FIG. 5) at sides 31a, 31b, respectively. In FIG. 3, the exterior surface 12a of the mask body 12 is seen and, in FIG. 6, the interior surface 12b of the mask body 12 is seen. In accordance with the present invention, the filtering face-piece respirator 10 includes a region having an increased coefficient of friction, as compared to the coefficient of friction of the filtering structure 16, at the perimeter 24 of the interior surface 12b of the mask body 12. In FIG. 6, this region of increased coefficient of friction 44 extends along the entire perimeter 24 (i.e., the entire length of both the upper segment 24a and the lower segment 24b) forming a continuous ring or perimeter around the mask body 12. In some embodiments, this region of increased coefficient of friction 44 may be present only in the upper segment 24a, only in the lower segment 24b, or have interruptions around the perimeter 24.

The region of increased coefficient of friction 44 is present on the interior surface 12b of the mask body 12, so that when a wearer wears the respirator 10, the region of increased coefficient of friction 44 contacts the wearer's face. Some portion of the region of increased coefficient of friction 44 may extend on the exterior surface 12a of the mask body 12, including on a perimeter edge defining a transition between the interior surface 12b and the exterior surface 12a.

FIGS. 6a and 6b show two variations of the region of increased coefficient of friction 44. In both embodiments, the region of increased coefficient of friction 44 is present both on the exterior surface 12a and the interior surface 12b; that is, the region of increased coefficient of friction 44 wraps around the perimeter 24. In other embodiments, not shown, the region of increased coefficient of friction 44 is present only on the interior surface 12b; the region of increased coefficient of friction 44 may extend to and contact the edge of the perimeter 24 or may be short thereof.

In FIG. 6a, the region of increased coefficient of friction 44 is applied to the filtering structure 16 which is then is folded at a fold 45, causing the region of increased coefficient of friction 44 to be present on both sides of the fold 45, on both the exterior surface 12a and the interior surface 12b.

In FIG. 6b, the region of increased coefficient of friction 44 is wrapped around the filtering structure 16 including the edge of the filtering structure 16 that forms the perimeter 24, causing the region of increased coefficient of friction 44 to be present on both the exterior surface 12a and the interior surface 12b.

The region 44 provides increased holding of the respirator 10 to the wearer's face, compared to respirators having no such region 44, while maintaining adequate fluid (e.g., moisture laden air) flow while inhibiting build-up of moisture droplets at the region 44. The region 44 can be described as having a non-slip surface that is non-sticky and non-tacky to the touch at room temperature and humidity, when the mask is not being used (i.e., not positioned on the face of a wearer). Even though the region 44 provides increased holding of the respirator 10 to the wearer's face, it is not an adhesive surface and avoids the need for a release liner thereon. Although non-adhesive, non-tacky and non-sticky, the region 44 provides a suitable amount of stiction between the wearer's face and the respirator 10.

The region 44 has a coefficient of friction of at least 0.5, and in some embodiments, at least 0.55. In other embodiments, the coefficient of friction is at least 0.75. This coefficient of friction (i.e., of at least 0.5, etc.) may be either a “static coefficient of friction,” which is the coefficient of friction that applies to objects that are motionless, or a “dynamic coefficient of friction,” which is the coefficient of friction that applies to objects that are in motion. Typically, the static coefficient of friction and the dynamic coefficient of friction are within 2% of each other.

As a variation to a coefficient of friction measurement, the region 44 has a frictional resistance measurable by a “slip angle friction test”. This slip angle friction test utilizes an inclined plane and a standard U.S. quarter ($0.25) coin to simply quantify a friction value. For the test, the material to be tested is placed on a rigid, adjustable inclined plastic (e.g., acrylic) surface. Two parallel lines, 3 inches apart down slope, are marked on the test material. A U.S. quarter coin is placed (tail side down) above the top line, with the edge of the coin touching the line. The angle of the plane is gradually increased until the quarter slides down the slope and contacts the bottom line. The angle of the plane is recorded, and the test is repeated five times and the angle value is averaged. The region 44 has a slippage angle, as tested by the “slip angle friction test”, of at least 25 degrees, in some embodiments at least 30 degrees. A typical cover web 38, 40 has a slippage angle of less than 20 degrees, e.g., less than 17 degrees.

The region 44 further has a permeability of at least 100 cfm/ft², in some embodiments at least 200 cfm/ft². A permeability in the range of 200 cfm/ft² to 300 cfm/ft² is desired to provide good air flow and comfort to the wearer.

Region 44 may be applied directly onto the filtering structure 16, for example, coated on to the filtering structure 16, or region 44 may be a discrete member that is attached to the filtering structure 16. FIGS. 7, 8 and 9 show three suitable embodiments of a discrete member 46 having an increased coefficient of friction as compared to the filtering structure 16. These members 46 can be applied to the mask body 12 to create the region of increased coefficient of friction 44. Each of the members 46 of FIGS. 7, 8 and 9 are constructions having a base structure with a polymeric friction material thereon; examples of suitable polymeric materials to provide the desired frictional surface include polyethylene(s), urethane(s), polyolefin(s), polypropylene(s) and mixtures thereof. Depending on the polymeric pattern, the surface area coverage, and the particular polymeric material, the frictional material may increase the bonding strength at the line of demarcation 36a, 36b (FIGS. 4A, 4B), when the discrete member 46 is welded simultaneously with the filtering structure 16 to form flanges 30a, 30b.

The discrete member 46 has a thickness no more than 0.5 mm, in some embodiments, no more than 0.25 mm, and in other embodiments no more than 0.2 mm. The thinness of the discrete member 46 maintains the conformability and ability of the respirator 10 to adequately seal to the wearer's face.

The member 46 of FIG. 7 is an elongate, tape-like base structure 50 having a width W and a surface 52 on which are present areas 54 of polymeric friction material. These areas 54 are irregular yet discrete dots of the polymeric friction material, with exposed regions of the surface 52 surrounding each of the areas 54.

The member 46 of FIG. 8 is an elongate, tape-like base structure 60 having a width W and a surface 62 on which are present areas 64 of the polymeric friction material. These areas 64 are continuous stripes of the polymeric friction material extending across the width W, with exposed regions of the surface 62 present between adjacent areas 64.

The member 46 of FIG. 9 is an elongate, tape-like base structure 70 having a width W and a surface 72 on which are present areas 74 of polymeric friction material. These areas 74 are regular, polygonal area of the polymeric friction material, arranged in a regular pattern, with exposed regions of the surface 72 surrounding each of the areas 74.

The areas 54, 64, 74 occupy at least 20% and no more than 70% of the surface 52, 62, 72 in some embodiments occupy no more than 50%. In addition to irregular circular or dotted areas 54, striped areas 64, and diamond areas 74, the frictional area can be in configuration including any irregular shape, polygonal shape, swirls, squiggles, continuous line or stripes and discontinuous lines or stripes. The frictional areas 54, 64, 74 may have a regular or irregular pattern of the polymeric friction material. However, no matter what pattern of frictional area, the areas 54, 64, 74 should provide a path through the tape-like structure 50, 60, 70 to allow flow of fluid (e.g., moisture laden air) therethrough.

The tape-like base structure 50, 60, 70 is a porous material and is moisture permeable. A suitable base structure 50, 60, 70 is a non-woven material (e.g., polypropylene, polyethylene) and in some embodiments, the tape-like base structures 50, 60, 70 may be a laminate material. Also in some embodiments, the tape-like base structures 50, 60, 70 may have an elastic feature or property. An elastic component to base structures 50, 60, 70 or to discrete member 46, in general, increases the ability of the respirator 10 to conform to the wearer's face and provide and adequate seal.

Another suitable base structure is a non-porous tape-like base structure having a plurality of apertures there though, the apertures allowing moisture passage through the entire structure; thus, the overall base structure is porous. In such a structure, no additional frictional material may be present thereon, but the friction member 46 receives its coefficient of friction from the base structure.

Additional examples of suitable discrete members 46 having an increased coefficient of friction as compared to the filtering structure 16 include those materials known as stretch laminates and/or stretch bonded laminates. These materials often are a composite material having at least two layers in which one layer is a gatherable layer and the other layer is an elastic layer. The layers are joined together when the elastic layer is extended from its original condition so that upon relaxing the layers, the gatherable layer is gathered. Such a multilayer composite elastic material may be stretched to the extent that the non-elastic material gathered between the bond locations allows the elastic material to elongate. Elastic nonwovens, which may be a single nonwoven layer that includes elastic fibers, are also suitable as a discrete member 46.

Testing was done on various discrete friction members 46 and on conventional cover webs (e.g., inner cover web 38 of FIG. 5) as well as a polymeric film (e.g., gasket material). The permeability of the materials was tested using a Frazier Air Permeability Machine and in accordance with ASTM D461-67, the coefficient of friction (both static and dynamic) were tested in accordance with ASTM D1894-11e1 “Standard Test Method for Static and Kinetic Coefficients of Friction of Plastic Film and Sheeting”, and the Slip Angle Friction Test was done as described above. For each of the tests, 5 to 10 samples were tested and the results were averaged. Table 1 summarizes the properties of the tested materials, where:
Control #1 was a conventional inner cover web, particularly, a light weight spun bond polypropylene nonwoven web;
Control #2 was a conventional inner cover web, particularly, a heavy weight spun bond polypropylene nonwoven web;
Control #3 was a solid, linear low density polyethylene (LLDPE) film, having a thickness of approximately 0.1 mm;
Sample #1 was an elastic nonwoven material commercially available from National Bridge Industrial Co., Ltd., Shenzhen, China under the trade designation “Marnix”;
Sample #2 had a coating of an amorphous polyolefin polymer on a heavy weight spun bond polypropylene nonwoven web, the polymer being provided as 0.06 mm thick parallel stripes with uncoated areas of 1.5 mm between adjacent stripes;
Control #4 was the base material from Sample #2 (i.e., without the polymeric friction material);
Sample #3 had a coating of an amorphous polyolefin polymer on a light weight spun bond polypropylene nonwoven web, the polymer being provided as smeared, irregular regions covering about 45-55% of the surface area of the web; and
Control #5 was the base material from Sample #3 (i.e., without the polymeric friction material).

TABLE 1

| | | Static Coeff. | Dynamic Coeff. | Slip angle |
|---|---|---|---|---|
| | Permeability, | of Friction | of Friction | friction |
| | cfm/ft² | (μₛ) | (μ_{d}) | test, degrees |
| Control #1 | 206 | 0.25 | 0.23 | 16.4 |
| Control #2 | 191 | 0.23 | 0.21 | 15 |
| Control #3 | 0 | 0.34 | 0.3 | 30 |
| Sample #1 | 237 | 0.97 | 0.98 | 41.6 |
| Sample #2 | 270 | 0.56 | 0.55 | 26.8 |
| Control #4 | 373 | not tested | not tested | not tested |
| Sample #3 | 283 | 0.79 | 0.79 | 29.4 |
| Control #5 | 702 | not tested | not tested | not tested |

As indicated above, the discrete friction member(s) 46 can be applied to the mask body 12 to create the region of increased coefficient of friction 44. The friction member 46 may be applied by an adhesive, mechanically (e.g., sewing, stapling), or may be ultrasonically and/or thermally welded to the filtering structure 16.

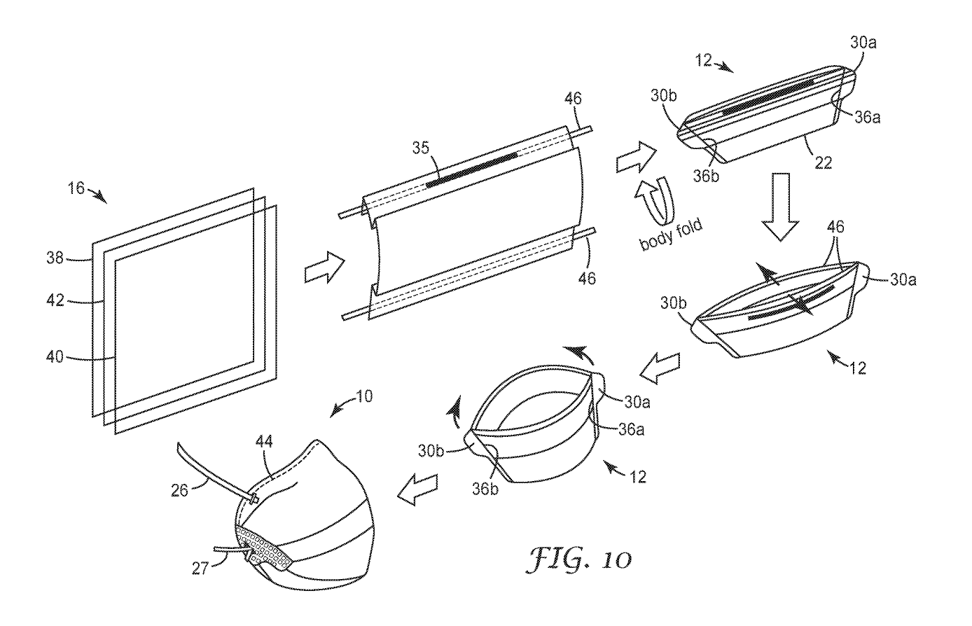

FIG. 10 illustrates an exemplary method for forming a flat-fold filtering face-piece respirator 10 having a mask body 12 with a region of increased coefficient of friction 44 extending around the entire perimeter 24, i.e., both at the upper perimeter segment 24a and the lower perimeter segment 24b. The respirator 10 is assembled in two operations—preform making and mask finishing. The preform making stage includes the steps of (a) lamination and fixing of nonwoven fibrous webs, (b) formation of pleats, (c) attaching the friction members to the filtering structure, (d) folding the mask body, (e) fusing both the lateral mask edges and reinforced flange material, and (f) cutting the final form, which may be done in any sequence(s) and combination(s). The mask finishing operation includes the steps of (a) opening the mask body, (b) folding and attaching flanges against the mask body, and (c) attaching a harness (e.g., straps).

At least portions of this method can be considered a continuous process rather than a batch process. For example, the preform mask can be made by a process that is continuous in the machine direction. Additionally, the friction member(s), at the edges of the filtering structure, are attached to the filtering structure as it progresses in the machine direction.

Referring to FIG. 10, three individual material sheets, an inner cover web 38, an outer cover web 40, and a filtration layer 42, are brought together and plied face-to-face to form an extended length of filtering structure 16. These materials are laminated together, for example, by adhesive, thermal welding, or ultrasonic welding, and cut to desired size.

Two extended lengths of a friction member 46 are brought to the upper edge and the lower edge of the filtering structure 16, respectively, in a parallel manner and sealed thereto, for example by ultrasonic and/or thermal welding. These friction members 46 are present in that part which will result in the upper perimeter segment 24a and the lower perimeter segment 24b (FIG. 6). A nose clip 35 may be attached to the filtering structure 16. The filtering structure 16 laminate is then folded and/or pleated and various seals and bonds are made to form various features, such as the demarcation line 22 and demarcation lines 36a, 36b and flanges 30a, 30b, on the flat mask body. At the demarcation lines 36a, 36b the friction members 46 are sealed together, forming a continuous ring around the flat blank.

The mask body 12 is expanded to a cup shape, flanges 30a, 30b can be folded against the filtering structure 16, and straps 26, 27 can be added, resulting in the flat-fold filtering face-piece respirator 10 with a region of increased coefficient of friction 44 present around the perimeter of the mask body 12, at the upper perimeter segment 24a and the lower perimeter segment 24b.

This invention may take on various modifications and alterations without departing from its spirit and scope. Accordingly, this invention is not limited to the above-described but is to be controlled by the limitations set forth in the following claims and any equivalents thereof. As an example, the frictional member of this invention may be incorporated into ‘flat’ face masks, such as those commonly used in the medical profession, or in vertical fold face masks, such as described in, for example, U.S. Pat. No. 6,394,090 to Chen et al. As another example, the frictional member of this invention may be non-continuous around the perimeter, but the mask body may have regions without the frictional member.

This invention also may be suitably practiced in the absence of any element not specifically disclosed herein.

All patents and patent applications cited above, including those in the Background section, are incorporated by reference into this document in total. To the extent there is a conflict or discrepancy between the disclosure in such incorporated document and the above specification, the above specification will control.

1-11. (canceled)

12. A method of making a filtering face-piece respirator that comprises:
(a) providing a filtering structure having a first edge and a second edge;
(b) applying a first extended length of a friction member proximate the first edge of the filtering structure to form a first friction member and a second extended length of friction member proximate the second edge of the filtering structure and parallel to the first friction member to form a second friction member;
(c) forming a series of folds, creases and/or pleats in the filtering structure; and
(d) forming a mask body from the filtering structure, the first edge and the first friction member, and the second edge and the second friction member forming a perimeter of the mask body.

13. The method of claim 12 wherein each of the first friction member and the second friction member has a coefficient of friction of at least 0.5 and a permeability of at least 100 cfm/ft².

14. The method of claim 12 wherein each of the first friction member and the second friction member has a coefficient of at least 0.55 and a permeability of at least 200 cfm/ft².

15. The method of claim 12 wherein each of the first friction member and the second friction member has a thickness of no more than 0.5 mm.

16. The method of claim 12 wherein the step of applying the extended lengths of the friction members is a continuous machine direction process.

17. The method of claim 12 wherein the step of forming a mask body comprises forming a mask body with the first edge and the first friction member, and the second edge and the second friction member forming a continuous perimeter of the mask body.

18. The method of claim 12 wherein forming a mask body comprises forming a mask body with the first friction member and the second friction member present on an interior surface of the mask body and on an exterior surface of the mask body.

19. The method of claim 18 wherein forming a mask body with the first friction member and the second friction member present on an interior surface of the mask body and on an exterior surface of the mask body comprises wrapping the first friction member around the first edge of the filtering structure and wrapping the second friction member around the second edge of the filtering structure.

20. The method of claim 12, further comprising sealing the first friction member to the first edge of the filtering structure and the second friction member to the second edge of the filtering structure prior to forming the series of folds, creases and/or pleats in the filtering structure.

21. The method of claim 12, wherein each of the first friction member and the second friction member comprises an amorphous polyolefin polymer on a nonwoven web.

22. The method of claim 21, wherein the nonwoven web comprises a polypropylene nonwoven web.

23. The method of claim 12, wherein each of the first friction member and the second friction member comprises an elastic nonwoven material.

24. The method of claim 12, wherein providing the filtering structure comprises laminating together an inner cover web, an outer cover web, and a filtration layer.

25. The method of claim 24, wherein laminating together the inner cover web, the outer cover web, and the filtration layer comprises ultrasonically welding together the inner cover web, the outer cover web, and the filtration layer.

26. The method of claim 12, further comprising attaching a nose clip to the filtering structure.
